(19) United States
(12) Patent Application Publication
(10) Pub. No.: US 2023/0093893 A1
(43) Pub. Date: Mar. 30, 2023

(54) DELIVERY MANAGEMENT DEVICE, DISPLAY TERMINAL, DELIVERY MANAGEMENT SYSTEM, AND DELIVERY MANAGEMENT METHOD

(71) Applicant: Panasonic Intellectual Property Management Co., Ltd., Osaka (JP)

(72) Inventors: Akihiko IGUCHI, OSAKA FU (JP); Takamasa UEDA, KANAGAWA KEN (JP); Takuma IIDA, KANAGAWA KEN (JP)

(73) Assignee: Panasonic Intellectual Property Management Co., Ltd., Osaka (JP)

(21) Appl. No.: 18/072,409

(22) Filed: Nov. 30, 2022

Related U.S. Application Data
(63) Continuation of application No. PCT/JP2021/024589, filed on Jun. 29, 2021.

(30) Foreign Application Priority Data
Jun. 30, 2020 (JP) 2020-113175

(51) Int. Cl. G06Q 10/0631; G06Q 10/083; G06Q 50/30; B60L 58/16

(52) U.S. Cl. CPC G06Q 10/06312; G06Q 10/083; G06Q 50/30; B60L 58/16; B60L 2260/52; B60L 2260/54

(57) ABSTRACT

A delivery management device includes a hardware processor functioning as a delivery planning unit, a charging planning unit, and a delivery management unit. The delivery planning unit serves to create a delivery plan on the basis of delivery information. The charging planning unit serves to determine whether or not en-route charging is necessary. The en-route charging is performed to charge a battery mounted on a moving body midway through a delivery route defined in the delivery plan. The delivery management unit serves to determine whether or not to re-plan the delivery plan including the en-route charging. The determination is made on the basis of a deterioration state of the battery. Also, the determination is made in a case where the en-route charging is determined as being necessary and where a battery deterioration amount is set as a priority item.

### CROSS-REFERENCE TO RELATED APPLICATIONS

This application is a continuation of International Application No. PCT/JP2021/024589, filed on Jun. 29, 2021, which claims the benefit of priority of the prior Japanese Patent Application No. 2020-113175, filed on Jun. 30, 2020, the entire contents of which are incorporated herein by reference.

### FIELD

The present disclosure relates to a delivery management device, a display terminal, a delivery management system, and a delivery management method.

### BACKGROUND

In the related art, various moving bodies using a battery, such as electric vehicles and hybrid electric vehicles, are utilized for various types of delivery such as home delivery. Under such circumstances, known is technology of creating a plan including en-route charging for charging midway through traveling on the basis of, for example, a remaining capacity of a battery and estimation of a power consumption amount (for example, Japanese Patent Application Laid-open No. 2011-253257).

In a case where a delivery plan includes en-route charging, it is possible to increase the delivery amount by a moving body. However, from the viewpoint of suppressing battery deterioration, it may be preferable not to perform en-route charging. But, in a delivery plan not including en-route charging, the delivery amount by a moving body may be limited.

In view of the above, it is desirable to create a delivery plan in consideration of both increase in delivery amount and suppression of battery deterioration.

### SUMMARY

A delivery management device according to the present disclosure includes a hardware processor connected to a memory. The hardware processor is configured to function as a delivery planning unit, a charging planning unit, and a delivery management unit. The delivery planning unit serves to create a delivery plan on the basis of delivery information related to delivery destinations and of accumulated battery data. The charging planning unit serves to determine whether or not en-route charging is necessary. The en-route charging is performed to charge a battery mounted on a moving body midway through a delivery route defined in the delivery plan. The determination by the charging planning unit is made on the basis of power consumption of the moving body, the power consumption estimated from the delivery plan, and characteristics of the battery. The delivery management unit serves to determine whether or not to re-plan the delivery plan including the en-route charging. The determination by the delivery management unit is made on the basis of a deterioration state of the battery of the moving body. Also, the determination by the delivery management unit is made in a case where the en-route charging is determined as being necessary and where a battery deterioration amount is set as a priority item from among a delivery amount and the battery deterioration amount for delivery by the moving body.

### BRIEF DESCRIPTION OF THE DRAWINGS

FIG. 1 is a block diagram illustrating an example of a configuration of a management system according to an embodiment;

FIG. 2 is a block diagram illustrating an example of a hardware configuration of a display terminal according to the embodiment;

FIG. 3 is a block diagram illustrating an example of a hardware configuration of a management device according to the embodiment;

FIG. 4 is a block diagram illustrating an example of a functional configuration of the display terminal according to the embodiment;

FIG. 5 is a block diagram illustrating an example of a functional configuration of the management device according to the embodiment;

FIG. 6 is a flowchart illustrating an example of delivery management processing executed by the management device according to the embodiment;

FIG. 7 is a flowchart illustrating an example of the delivery management processing executed by the display terminal according to the embodiment; and

FIG. 8 is a diagram illustrating an example of a display screen of the display terminal according to the embodiment.

### DETAILED DESCRIPTION

Hereinafter, embodiments of a delivery management device, a display terminal, a delivery management system, and a delivery management method according to the present disclosure will be described with reference to the drawings. Note that, in the following embodiments, “time” refers to a time point. Moreover, a “period of time” refers to a length, that is, a range, from a time to another time thereafter.

Hereinafter, a case where the technology according to the present disclosure is applied to various types of delivery, such as home delivery, will be described as an example. Note that the technology according to the present disclosure can be applied not only to parcels but also to a case of transporting a person, such as ridesharing, shared taxies, or buses. Moreover, the technology according to the present disclosure can also be applied to a case where multiple users use the same moving body, such as car rentals or bicycle rentals.

In the related art, various moving bodies using a battery, such as electric vehicles and hybrid electric vehicles, are utilized for various types of delivery such as home delivery. Under such circumstances, known is technology of creating a plan including en-route charging for charging midway through traveling, for example, on the basis of a remaining capacity of a battery and estimation of a power consumption amount. Also, known is technology for creating a delivery plan, for example, on the basis of states of health (SOH) indicating the deterioration state of a battery.

In a case where a delivery plan includes en-route charging, it is possible to increase the delivery amount by a moving body. Under such circumstances, in en-route charging performed on the way of delivery, unlike charging performed at night or the like, it is often impossible to ensure a sufficient period of time for charging with suppressed battery deterioration. Therefore, the en-route charging performed on the way of the delivery is generally performed by quick charging from the viewpoint of reducing the time required for delivery and improving the delivery efficiency. However, from the viewpoint of suppressing battery deterioration, it is preferable that en-route charging by quick charging not be performed. In addition, in a delivery plan not including en-route charging, the delivery amount by a moving body may be limited.

Moreover, a different one of the delivery amount and the battery deterioration amount may be required for each delivery in accordance with a delivery administrator's determination, which depends on various factors such as the state of the battery of the moving body, the number of drivers, the number of moving bodies, the size of the delivery amount, and the number of delivery destinations. For these reasons, it has been difficult to create a delivery plan in consideration of the delivery amount and suppression of battery deterioration.

Considering the above, a management system 1 according to the embodiment is configured to be able to create a delivery plan in consideration of both increase in delivery amount and suppression of battery deterioration, by determining the necessity of re-planning regarding the delivery plan including en-route charging on the basis of settings of a priority item and the SOH of the moving body. As the SOH, a capacity retention ratio indicating a deterioration state of the capacity as compared to that in the initial stage may be used, a resistivity increase ratio indicating the deterioration state of the resistance as compared to that in the initial stage may be used, or both of them may be used.

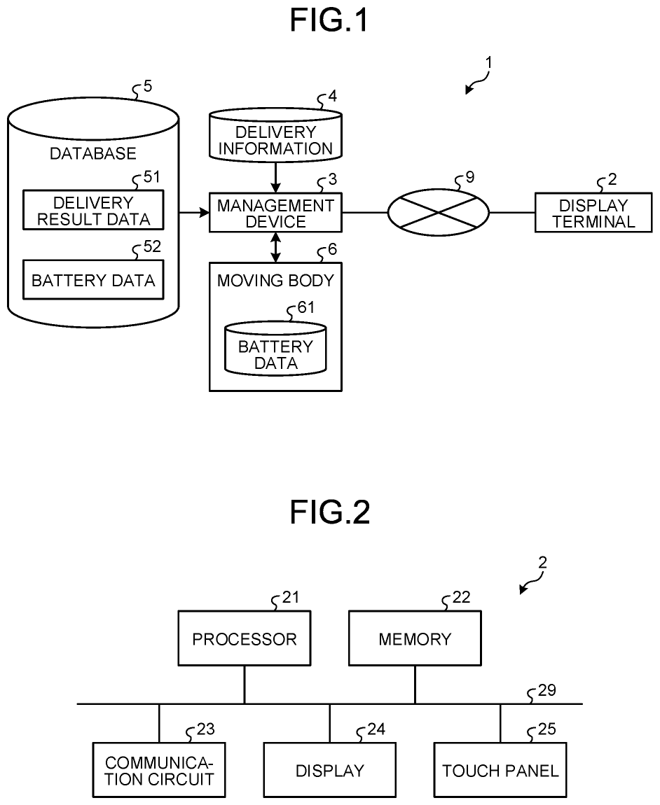

FIG. 1 is a block diagram illustrating an example of a configuration of the management system 1 according to the embodiment. The management system 1 according to the embodiment is a delivery management system that manages delivery of various articles to delivery destinations. The management system 1 is also a charge management system that manages charging of a battery mounted on a moving body 6 used for delivery. While the management system 1 including one moving body 6 is illustrated in FIG. 1, it is not limited thereto. The management system 1 may include two or more moving bodies 6.

As illustrated in FIG. 1, the management system 1 includes a display terminal 2 and a management device 3. The display terminal 2 and the management device 3 are connected to each other via a network 9 so that they can communicate with each other. As the network 9, for example, an electric communication line such as the Internet can be used. As an example, the management system 1 can be configured as a server-client type system including the display terminal 2 as a client device and the management device 3 as a server device. As the display terminal 2, a smartphone, a tablet PC, a car navigation system, or the like can be used as appropriate. As the management device 3, a server device, a PC, or the like can be used as appropriate.

The display terminal 2 displays information such as a delivery plan, a charging plan, and a re-planning notification regarding each of the moving bodies 6. Information such as a delivery plan, a charging plan, and a re-planning notification displayed on the display terminal 2 is supplied by the management device 3. The management device 3 is a device that prepares a delivery plan and a charging plan for each of the delivery vehicles. Additionally, the management device 3 acquires information such as an actual electric energy amount and the SOH of a battery of the moving body 6. The management device 3 is an example of a delivery management device.

The delivery plan refers to a plan of delivery prepared on the basis of delivery information, accumulated delivery result data, accumulated battery data, and others. The delivery plan includes information about a delivery route related to delivery destinations and delivery time or time required for delivery related to each of the delivery destinations. As an example, the delivery plan is created from the viewpoint of suppressing battery deterioration. Specifically, the delivery plan is created such that the value of the power consumption amount or the battery deterioration amount estimated in a case where delivery is performed by using the delivery route becomes small. In the delivery plan, en-route charging for charging the battery on the way of delivery may be set in accordance with, for example, the number of delivery destinations, the length of the delivery route, the delivery amount, or the like. The charging plan refers to a plan for charging a battery mounted on a delivery vehicle. Such a plan is prepared in accordance with the delivery plan from the viewpoint of suppressing battery deterioration. The charging plan is a plan of charging executed between delivery and delivery, for example, at night or on the way of delivery. Note that the en-route charging may be quick charging.

FIG. 2 is a block diagram illustrating an example of a hardware configuration of the display terminal 2 according to the embodiment. As illustrated in FIG. 2, the display terminal 2 includes a processor 21 (an example of a hardware processor), a memory 22, a communication circuit 23, a display 24, and a touch panel 25. The processor 21, the memory 22, the communication circuit 23, the display 24, and the touch panel 25 are connected via, for example, a bus 29 so that they can communicate with each other.

The processor 21 controls the entire operation of the display terminal 2. The memory 22 stores various types of data or computer programs used by the display terminal 2. The data stored in the memory 22 includes data received from the management device 3. The programs stored in the memory 22 include a delivery management program of a terminal side described later. The communication circuit 23 is a circuit for communicating with the outside of the display terminal 2 via the network 9. The display 24 shows a display screen to a user. As the display 24, a liquid crystal display, an organic EL display, a projector, or the like can be used as appropriate. The touch panel 25 receives input by a user. The touch panel 25 is provided on the surface of the display 24 and outputs information corresponding to a position that is touched.

Note that the display terminal 2 is not limited to the touch panel 25 and may include another input device such as a keyboard. In addition, the display terminal 2 may further include a microphone as an input device for receiving voice input of the user, a speaker as an output device for outputting audio corresponding to audio data, and the like. In these cases, in the display terminal 2, the content of the display screen including the delivery plan, the charging plan, and a re-planning notification described later may be presented to the user by speech, or selection for the re-planning notification may be input by speech.

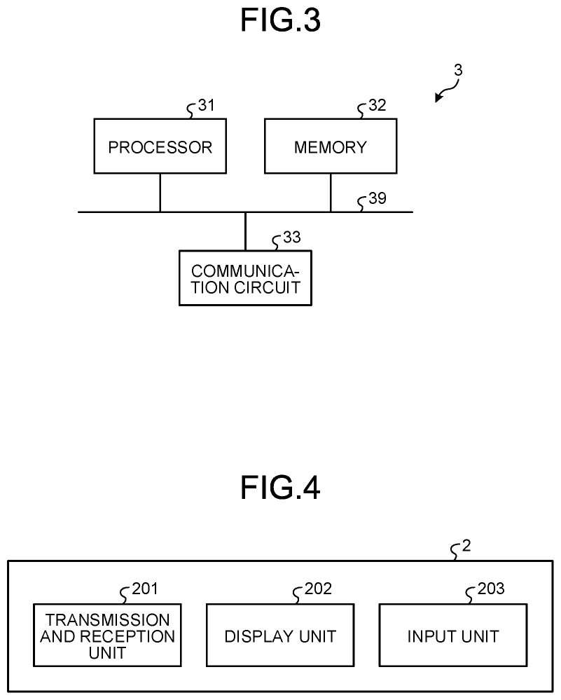

FIG. 3 is a block diagram illustrating an example of a hardware configuration of the management device 3 according to the embodiment. As illustrated in FIG. 3, the management device 3 includes a processor 31 (an example of a hardware processor), a memory 32, and a communication circuit 33. The processor 31, the memory 32, and the communication circuit 33 are connected via, for example, a bus 39 so that they can communicate with each other.

Note that the management device 3 may be connected to at least one of a database storing delivery information 4, a database 5, and the moving body 6 in an accessible manner via the network 9. In addition, the management device 3 may be configured to be capable of accessing at least one of the database storing the delivery information 4, the database 5, and the moving body 6 via a computer-readable recording medium or a portable external storage device. As the computer-readable recording medium, for example, a CD-ROM, a flexible disk (FD), a CD-R, a digital versatile disk (DVD), or the like can be used as appropriate. As the portable external storage device, a hard disk drive (HDD), a solid state drive (SSD), a flash memory, or the like can be used as appropriate.

The processor 31 controls the entire operation of the management device 3. The memory 32 stores various types of data or computer programs used by the management device 3. The data stored in the memory 32 includes data received from the display terminal 2, the database storing the delivery information 4, the database 5, and the moving body 6. The programs stored in the memory 32 include a delivery management program of the server side to be described later. The communication circuit 33 is a circuit for communicating with the outside of the management device 3.

Note that the management device 3 may include an input device for receiving input from a user, such as a touch panel or a keyboard. In addition, the management device 3 may include a display device for presenting a display screen to the user, such as a liquid crystal display, an organic EL display, or a projector.

As illustrated in FIG. 1, the management system 1 includes the database storing the delivery information 4, the database 5, and the moving body 6. In the management system 1, the management device 3 is connected to each of the database storing the delivery information 4, the database 5, and the moving body 6 in an accessible manner.

The database storing the delivery information 4 may be stored in, for example, a computer, a data server, or the like managed by a company to which the delivery driver belongs. The delivery information 4 is information set for each driver or each moving body 6 and is information indicating the name or the address of a delivery destination regarding each of parcels and delivery time or time required for delivery to the delivery destination. The delivery information 4 may include map data used for calculation of a delivery route, information about traffic congestion occurring on a road, and others. The delivery information 4 may also include information such as the floor number of the delivery destination, the presence or absence of an elevator, and the size, the weight, or the number of articles to be delivered to the delivery destination.

The database 5 is a database that stores delivery result data 51 and battery data 52. The database 5 may be stored in, for example, a computer, a data server, or the like managed by the company to which the delivery driver belongs. The delivery result data 51 is, for example, history data accumulated for each driver who is the operator of the moving body 6. The delivery result data 51 includes, for example, information indicating delivery information about the delivery that has been made, a delivery route that has been used, and characteristics of the moving body 6 that has been used. The characteristics of the moving body 6 include, for example, in a case where the moving body 6 is a vehicle, the weight of the vehicle, the type of the vehicle such as whether the vehicle is an electric vehicle or a hybrid electric vehicle, the type of the battery mounted, the presence or absence of a regenerative brake, or others. The battery data 52 is information indicating characteristics of the battery mounted on the moving body 6 such as a delivery vehicle. The information indicating the characteristics of the battery is, for example, information indicating the SOH, the capacity, the maximum output, the rated output, output fluctuations according to a load, and others of the battery.

The moving body 6 is a moving body that transports various articles to delivery destinations. As the moving body 6, various moving bodies driven with a battery can be used as appropriate. The moving body 6 may be a delivery vehicle using a battery, such as an electric vehicle or a hybrid electric vehicle. The moving body 6 includes a processor, a memory, and a communication circuit similarly to the management device 3 illustrated in FIG. 3. The processor of the moving body 6 controls the entire operation of the moving body 6. The memory of the moving body 6 stores various types of data and programs used by the moving body 6. The data stored in the memory of the moving body 6 includes battery data 61. The communication circuit of the moving body 6 is a circuit for communicating with the outside of the moving body 6.

The battery data 61 is information indicating the state of the battery mounted on the moving body 6. Note that the battery data 61 may include information indicating characteristics of the battery. As an example, the information indicating the state of the battery is information that indicates the capacity at that time, that is, states of charge (SOC) or the SOH indicating the charging state, the temperature, the energizing time, or others.

Note that, as the moving body 6, various vehicles such as a bicycle, a motorcycle, an automobile, and a train can be used as appropriate. In addition, the moving body 6 is not limited to these vehicles and may be various moving bodies using a battery such as a ship or an aircraft. Moreover, the moving body 6 may be a moving body that travels in a manned manner or may be a moving body that travels in an unmanned manner. Moreover, the travel of the moving body 6 may be controlled by the user or may be autonomously controlled in accordance with a set delivery route or the like.

As the processor 21, the processor 31, and the processor of the moving body 6, various processors such as a central processing unit (CPU), a graphics processing unit (GPU), an application specific integrated circuit (ASIC), and a field programmable gate array (FPGA) can be used separately as appropriate.

As the memory 22, the memory 32, and the memory of the moving body 6, various storage media and storage devices such as a read only memory (ROM), an HDD, an SSD, and a flash memory can be used separately as appropriate. Each of the memory 22, the memory 32, and the memory of the moving body 6 further includes a random access memory (RAM) that temporarily stores data being worked on.

As the communication circuit 23, the communication circuit 33, and the communication circuit of the moving body 6, a communication circuit for wired communication, a communication circuit for wireless communication, and a combination thereof can be used separately as appropriate. As the communication circuit for wireless communication, a communication circuit compatible with various standards such as 3G, 4G, 5G, Wi-Fi (registered trademark), or Bluetooth (registered trademark) can be used as appropriate.

Note that the database storing the delivery information 4 and the database 5 may be stored in one server or may be stored in two or more servers in a distributed manner. At least one of the database storing the delivery information 4 and the database 5 may be stored in the display terminal 2, the management device 3, or the moving body 6.

Note that the database storing the delivery result data 51 and the database storing the battery data 52 are not limited to be configured as one database 5 and may be configured as separate databases.

FIG. 4 is a block diagram illustrating an example of a functional configuration of the display terminal 2 according to the embodiment. In the display terminal 2, functions as a transmission and reception unit 201, a display unit 202, and an input unit 203 are implemented by the processor 21 that executes, for example, the delivery management program of the terminal side loaded in the memory 22.

The transmission and reception unit 201 receives the delivery plan, the charging plan, the re-planning notification, and the like from the management device 3. The transmission and reception unit 201 transmits, to the management device 3, a user's selection received by the input unit 203 for setting a priority item or for responding to the re-planning notification.

The display unit 202 displays a display screen for setting a priority item. The display unit 202 displays the display screen including the re-planning notification received by the transmission and reception unit 201. The display unit 202 displays a display screen for selecting at least one change item from among the moving body 6, the delivery amount by the moving body 6, and the number of moving bodies 6 in response to reception of the re-planning notification by the transmission and reception unit 201. The display unit 202 may display a display screen containing a delivery plan including en-route charging, which has been determined to implement re-planning by the management device 3, or a charging plan created on the basis of the delivery plan. In addition, the display unit 202 displays at least one of: the delivery plan re-planned by the management device 3 in accordance with the selection of change items received by the input unit 203, and the charging plan created on the basis of the delivery plan. In a case where the management system 1 includes moving bodies 6, the display unit 202 displays various display screens such as a display screen for selecting a change item, a display screen containing a delivery plan, and a display screen containing a charging plan for each moving body 6, for example. Alternatively, in a case where moving bodies 6 are included in the management system 1, the display unit 202 displays a list of the moving bodies 6. The display unit 202 can display the above-described various display screens regarding the moving body 6 corresponding to the user's selection received by the input unit 203 from among the moving bodies 6 displayed in the list. That is, the user can confirm a re-planning notification, select a change item, or confirm a delivery plan, a delivery status, a charging plan, and a charging status for any moving body 6.

The input unit 203 receives user's selection of the change item with regards to settings of the priority item or the re-planning notification. In a case where moving bodies 6 are included in the management system 1, the input unit 203 receives settings of the priority item or selection of the change item for each moving body 6.

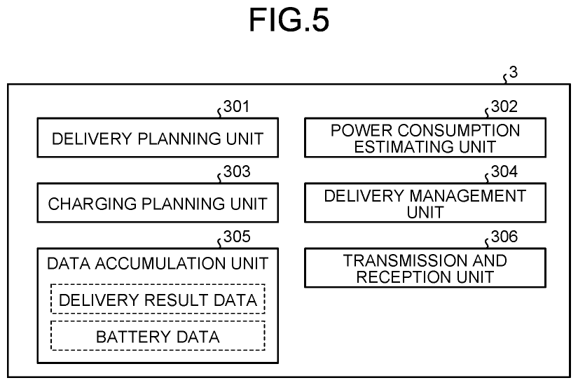

FIG. 5 is a block diagram illustrating an example of a functional configuration of the management device 3 according to the embodiment. The management device 3 implements functions as a delivery planning unit 301, a power consumption estimating unit 302, a charging planning unit 303, a delivery management unit 304, a data accumulation unit 305, and a transmission and reception unit 306 by, for example, the processor 31 executing the delivery management program of the server side loaded in the memory 32.

The delivery planning unit 301 creates the delivery plan on the basis of the delivery information 4 regarding delivery destinations, the delivery result data 51 that has been accumulated, and the battery data 52 that has been accumulated. As an example, the delivery plan is a delivery plan that has been created in order to suppress battery deterioration; however, it is not limited thereto. The delivery planning unit 301 can create a delivery plan including en-route charging to charge the battery of the moving body 6 during delivery, that is, on the delivery route. Note that the delivery planning unit 301 may create the delivery plan in accordance with the priority item set by the delivery management unit 304. For example, the delivery planning unit 301 may create a delivery plan for suppressing battery deterioration in a case where the battery deterioration amount is the priority item and may create a delivery plan for increasing the delivery amount in a case where the delivery amount is the priority item. In a case where the delivery management unit 304 determines to re-plan the delivery plan including en-route charging, the delivery planning unit 301 re-plans the delivery plan in accordance with result of the user's selection of change items from the display terminal 2. The delivery planning unit 301 re-plans the delivery plan by changing at least one of the moving body 6, the delivery amount by the moving body 6, and the number of moving bodies 6.

The power consumption estimating unit 302 calculates the power consumption amount that is estimated in a case where the delivery is performed in accordance with the delivery plan created by the delivery planning unit 301.

The charging planning unit 303 determines whether or not en-route charging is necessary. The determination is made on the basis of the estimation of the power consumption amount calculated by the power consumption estimating unit 302 and the battery data 61 of the moving body 6. The en-route charging refers to charging of the battery of the moving body 6 midway through the delivery route which is defined in the delivery plan created by the delivery planning unit 301. In addition, the charging planning unit 303 creates a charging plan on the basis of the estimation of the power consumption amount calculated by the power consumption estimating unit 302. As an example, the charging planning unit 303 creates a charging plan on the basis of the delivery plan, the estimated power consumption amount, the battery electric energy amount at the start of charging, the charging electric energy amount per unit time of a charger, and the battery data 61. The charging plan includes, for example, a start time of the charging, a target time for completion of charging, the duration of charging, and a target battery electric energy amount.

The delivery management unit 304 sets the priority item. The priority item is information indicating which of the delivery amount and the battery deterioration amount is prioritized in a delivery plan. The delivery management unit 304 sets the priority item on the basis of, for example, output of the display terminal 2 corresponding to input of the user. Note that the setting of the priority item may be performed on the basis of an input to the management device 3 or a value given and stored in advance in the memory 32. In a case where the battery deterioration amount is set as the priority item and where the charging planning unit 303 has determined that en-route charging is necessary, the delivery management unit 304 determines whether or not to re-plan a delivery plan including en-route charging. This determination is made on the basis of the SOH indicating the deterioration state of the battery of the moving body 6. Specifically, when the SOH is larger than a predetermined threshold value, the delivery management unit 304 determines not to re-plan and adopts a delivery plan including en-route charging. On the other hand, when the SOH is less than or equal to the predetermined threshold value, the delivery management unit 304 determines to re-plan and performs re-planning by the delivery planning unit 301. Note that the delivery management unit 304 adopts a delivery plan created by the delivery planning unit 301 in a case where the delivery amount is set as the priority item and where the charging planning unit 303 has determined that the en-route charging is necessary or in a case where the charging planning unit 303 has determined that the en-route charging is not necessary.

The data accumulation unit 305 accumulates the delivery result data 51 and the battery data 52.

The transmission and reception unit 306 receives delivery information from the database in which the delivery information 4 has been stored. The transmission and reception unit 306 receives the delivery result data 51 and the battery data 52 from the database 5 prior to creation of the delivery plan and the charging plan. The transmission and reception unit 306 then transmits the delivery result data 51 and the battery data 52 to the database 5 after completion of the delivery. The transmission and reception unit 306 receives the battery data 61 from the moving body 6. The transmission and reception unit 306 transmits the delivery plan, the charging plan, the re-planning notification, and others to the display terminal 2. The transmission and reception unit 306 receives, from the display terminal 2, settings of the priority item by the user or the user's selection of the change item in response to the re-planning notification.

Note that, in the management system 1, all or part of the functions implemented by the management device 3 may be implemented in the display terminal 2 or the moving body 6.

Hereinafter, the operation of the management system 1 according to the embodiment will be described with reference to the drawings. Note that the flow of processing described below is an example. Change in the processing order, deletion of part of the processing, and/or addition of other processing can be performed.

In the management system 1, server client processing is executed, which is implemented by the server-side delivery management processing executed by the management device 3 and the client-side delivery management processing executed by the display terminal 2.

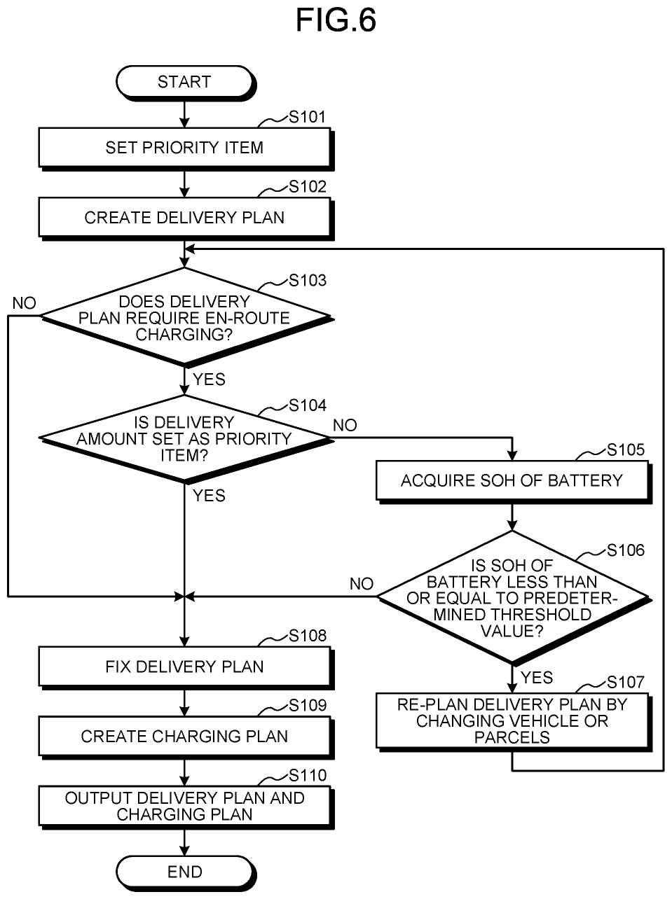

FIG. 6 is a flowchart illustrating an example of delivery management processing on the server side executed by the management device 3 according to the embodiment.

The delivery management unit 304 sets the priority item on the basis of, for example, output of the display terminal 2 corresponding to input of the user (S101). The priority item is information indicating which of the delivery amount and the battery deterioration amount is prioritized for fixing a delivery plan. After the priority item is set, the delivery planning unit 301 creates a delivery plan regarding delivery to delivery destinations (S102). The power consumption estimating unit 302 calculates the power consumption amount estimated in the delivery plan that has been created. Moreover, the charging planning unit 303 determines whether or not the delivery plan created by the delivery planning unit 301 is a delivery plan that requires en-route charging (S103). Specifically, the charging planning unit 303 determines whether or not en-route charging is necessary on the basis of the estimation of the power consumption amount calculated by the power consumption estimating unit 302 and the battery data 61 of the moving body 6.

1. Cases where En-Route Charging is Necessary

If the delivery plan requires en-route charging (S103: Yes), the delivery management unit 304 determines whether or not the priority item set in S101 is the delivery amount (S104).

1-1. Cases where Priority Item is Battery Deterioration Amount

If the set priority item is not the delivery amount but is the battery deterioration amount (S104: No), the transmission and reception unit 306 acquires the SOH from the moving body 6 (S105). The delivery management unit 304 determines whether or not the acquired SOH is less than or equal to the predetermined threshold value (S106). The predetermined threshold value may be a constant value or a value determined in accordance with the estimated power consumption amount. The predetermined threshold value or a calculation formula of the predetermined threshold value may be set in advance and stored in the memory 32 or the like, for example.

1-1-1. Cases where En-Route Charging is not Acceptable

If the acquired SOH is less than or equal to the predetermined threshold value (S106: Yes), the delivery management unit 304 performs re-planning of a delivery plan including en-route charging (S107). This is a case where the delivery in accordance with the delivery plan including en-route charging is not acceptable for the moving body 6 of the current delivery plan. Specifically, the delivery management unit 304 generates a re-planning notification. The transmission and reception unit 306 transmits the generated re-planning notification to the display terminal 2. Moreover, the transmission and reception unit 306 receives, from the display terminal 2, the user's selection of the change item in response to the re-planning notification. The delivery management unit 304 instructs the delivery planning unit 301 to re-plan the delivery plan on the basis of the selection result of the change item from the display terminal 2. The delivery planning unit 301 performs re-planning of the delivery plan on the basis of the selection result of the change item from the display terminal 2 similarly to the processing of S102. That is, the delivery planning unit 301 re-plans the delivery plan by changing at least one of the moving body 6, the delivery amount by the moving body 6, and the number of moving bodies 6. Note that, in a case where the moving body 6 is changed, the delivery management unit 304 may select any other moving body 6 and evaluate the SOH in the subsequent processing of S105 and S106, or may select, on the basis of the battery data 52, a moving body 6 whose SOH is greater than or equal to the predetermined threshold value from among other moving bodies 6. After that, the flow of FIG. 6 returns to the processing of S103.

1-1-2. Cases where En-Route Charging is Acceptable>

On the other hand, if the acquired SOH is greater than the predetermined threshold value (S106: No), the delivery management unit 304 fixes the delivery plan (S108). This is a case where the delivery in accordance with the delivery plan including en-route charging is acceptable for the moving body 6 of the current delivery plan. In other words, in a case where en-route charging is acceptable, the delivery management unit 304 adopts the delivery plan including en-route charging as the delivery plan used for delivery, on the basis of the fact that the priority item is the battery deterioration amount.

1-2. Cases where Priority Item is Delivery Amount

If the set priority item is the delivery amount (S104: Yes), the delivery management unit 304 fixes the delivery plan (S108). In other words, in a case where the priority item is the delivery amount, the delivery management unit 304 adopts the delivery plan to be used for delivery even when the delivery plan includes en-route charging.

2. Cases where En-Route Charging is Unnecessary

If the delivery plan does not require en-route charging (S103: No), the delivery management unit 304 fixes the delivery plan (S108). In other words, in a case where the delivery plan does not include en-route charging, the delivery management unit 304 adopts the delivery plan to be used for delivery regardless of the priority item. It can also be expressed that, in a case where the priority item is the delivery amount, the delivery management unit 304 adopts the delivery plan to be used for delivery regardless of the presence or absence of en-route charging.

After the delivery plan is fixed, the charging planning unit 303 creates a charging plan for suppressing battery deterioration on the basis of the estimation of the power consumption amount calculated in the processing of S103 for the fixed delivery plan (S109). Note that, in a case where the delivery plan includes en-route charging, the charging planning unit 303 may plan en-route charging for suppressing battery deterioration in accordance with the duration of charging accepted by the delivery plan. In other words, the en-route charging is not limited to quick charging. The delivery management unit 304 outputs the delivery plan fixed in the processing of S108 and the charging plan created in the processing of S109 (S110). Specifically, the delivery management unit 304 transmits the delivery plan and the charging plan to the display terminal 2 by the transmission and reception unit 306. Note that the delivery management unit 304 may transmit only either the delivery plan or the charging plan. The delivery management unit 304 can also transmit at least one of the delivery plan and the charging plan in response to a request from the display terminal 2. After that, the flow of FIG. 6 ends.

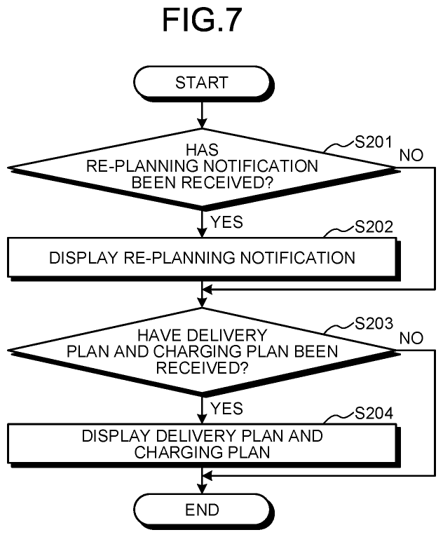

FIG. 7 is a flowchart illustrating an example of the delivery management processing on the client side executed by the display terminal 2 according to the embodiment. The flow of FIG. 7 is started in a state where the priority item has been set.

The display unit 202 determines whether or not the re-planning notification from the management device 3 has been received by the transmission and reception unit 201 (S201).

When the re-planning notification from the management device 3 is received (S201: Yes), the display unit 202 displays a display screen 810 including the received re-planning notification on the display 24 (S202). Moreover, the input unit 203 receives the selection of the change item by the user. The transmission and reception unit 201 then transmits the received selection result of the change item to the management device 3. After that, the flow of FIG. 7 proceeds to the processing of S203. On the other hand, if no re-planning notification from the management device 3 has been received (S201: No), the flow of FIG. 7 proceeds to the processing of S203.

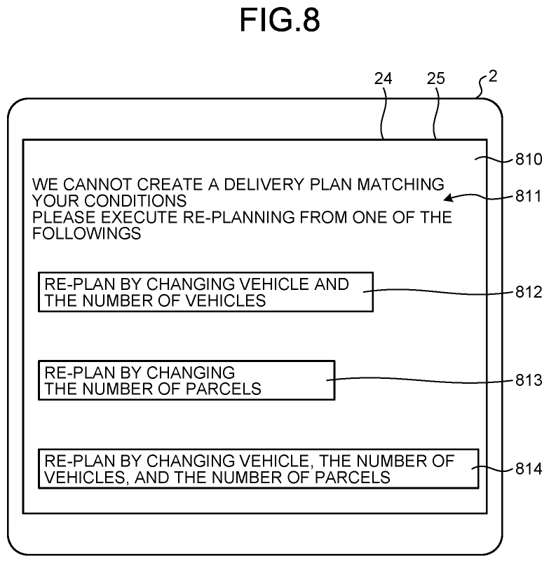

FIG. 8 is a diagram illustrating an example of the display screen 810 of the display terminal 2 according to the embodiment. As illustrated in FIG. 8, the display screen 810 includes a re-planning notification 811. In FIG. 8, illustrated is an example of the re-planning notification 811 of “WE CANNOT CREATE A DELIVERY PLAN MATCHING YOUR CONDITIONS. PLEASE EXECUTE RE-PLANNING FROM ONE OF THE FOLLOWINGS”. In addition, as illustrated in FIG. 8, the display screen 810 includes icons 812, 813, and 814 for selecting the change item. The icon 812 is an example of the input unit 203 that instructs to “RE-PLAN BY CHANGING VEHICLE AND THE NUMBER OF VEHICLES”. Here, to “RE-PLAN BY CHANGING VEHICLE AND THE NUMBER OF VEHICLES” means to change to another moving body 6 or to change the number of moving bodies 6 and to re-plan the delivery plan. The icon 813 is an example of the input unit 203 that instructs to “RE-PLAN BY CHANGING THE NUMBER OF PARCELS”. Here, to “RE-PLAN BY CHANGING THE NUMBER OF PARCELS” means to change the delivery amount by the moving body 6 and to re-plan a delivery plan. Note that changing the delivery amount by the moving body 6 may be implemented by changing the period of time allowed for delivery or changing a part or all of delivery destinations. The icon 814 is an example of the input unit 203 that instructs to “RE-PLAN BY CHANGING VEHICLE, THE NUMBER OF VEHICLES, AND THE NUMBER OF PARCELS”. Here, to “RE-PLAN BY CHANGING VEHICLE, THE NUMBER OF VEHICLES, AND THE NUMBER OF PARCELS” means to re-plan a delivery plan by changing the moving body 6, the number of moving bodies 6, and the delivery amount by the moving body 6.

Note that the display unit 202 may display, not limited to the icons 812, 813, and 814 exemplified in FIG. 8, but an icon instructing to change to another moving body 6, such as “re-plan by changing vehicle”. Moreover, the display unit 202 may display an icon instructing to change the number of moving bodies 6, such as “re-plan by changing the number of vehicles”. Moreover, the display unit 202 may display an icon instructing to change to another moving body 6 and to change the delivery amount by the moving body 6, such as “re-plan by changing vehicle and the number of parcels”. Moreover, the display unit 202 may display an icon instructing to change the number of moving bodies 6 and the delivery amount by the moving body 6, such as “re-plan by changing the number of vehicles and the number of parcels”. That is, the display unit 202 displays icons instructing to change at least one change item out of the moving body 6, the delivery amount by the moving body 6, and the number of moving bodies 6.

Note that the display unit 202 may display an icon instructing to change the priority item. In this case, the delivery management unit 304 of the management device 3 can determine the necessity of re-planning regarding the delivery plan including en-route charging by changing the priority item. Note that the delivery planning unit 301 may re-plan the delivery plan by changing the priority item.

Note that the display unit 202 may display an icon for instructing whether or not to perform re-planning. In this case, the delivery management unit 304 of the management device 3 may fix the delivery plan in the processing of S108 without performing re-planning in the processing of S107.

The display unit 202 determines whether or not the delivery plan and the charging plan have been received from the management device 3 by the transmission and reception unit 201 (S203). If the delivery plan and the charging plan from the management device 3 have been received (S203: Yes), the display unit 202 displays a display screen including the received delivery plan and the charging plan on the display 24 (S204). After that, the flow of FIG. 7 ends. On the other hand, if neither a delivery plan nor a charging plan from the management device 3 has been received (S203: No), the flow of FIG. 7 ends.

Note that the display unit 202 may display, on the display 24, a display screen including either the received delivery plan or the charging plan, in accordance with, for example, the user's input to the input unit 203. Moreover, the transmission and reception unit 201 may transmit a transmission request of at least one of the delivery plan and the charging plan to the management device 3, in accordance with, for example, the user's input to the input unit 203. In this case, the display unit 202 may display a display screen including at least one of the received delivery plan and the charging plan on the display 24.

Note that image data for the display screen 810 may be generated by the display unit 202 or may be generated in the management device 3.

As described above, in the management device 3 of the embodiment, the delivery planning unit 301 creates a delivery plan on the basis of the delivery information 4 regarding delivery destinations and the battery data 52 that has been accumulated. As an example, the delivery planning unit 301 creates a delivery plan so as to suppress deterioration of a battery mounted on the moving body 6. The power consumption estimating unit 302 calculates the power consumption amount of the moving body 6 estimated from the delivery plan. The charging planning unit 303 determines whether or not en-route charging is necessary on the basis of the calculated power consumption amount and the characteristics of the battery mounted on the moving body 6. In a case where the battery deterioration amount is set as the priority item and where en-route charging is determined as being necessary, the delivery management unit 304 determines whether or not to re-plan a delivery plan including en-route charging on the basis of the SOH indicating the deterioration state of the battery of the moving body 6.

With this configuration, the management device 3 can determine the necessity of re-planning regarding the delivery plan including en-route charging on the basis of the settings of the priority item and the SOH of the moving body 6. Therefore, according to the technology of the present disclosure, it is possible to create a delivery plan in consideration of the delivery amount and suppression of battery deterioration.

Moreover, in the display terminal 2 of the embodiment, in a case where a delivery plan including en-route charging is to be re-planned, the display unit 202 displays the display screen 810 for selecting at least one change item (that is, an item to be changed) from among the moving body 6, the delivery amount by the moving body 6, and the number of moving bodies 6. Moreover, the input unit 203 receives the selection of the change item by the user.

With this configuration, the display terminal 2 can display the display screen 810 for the user to reconsider the balance between the delivery amount and suppression of battery deterioration and to select the result of reconsideration as the change item in the re-planning regarding the delivery plan including en-route charging. Therefore, according to the technology of the present disclosure, it is possible to create a delivery plan in consideration of the delivery amount and suppression of battery deterioration also in re-planning.

A computer program executed by each of the display terminal 2, the management device 3, and the moving body 6 of the present embodiment may be provided by being recorded in a computer-readable recording medium such as a CD-ROM, an FD, a CD-R, or a DVD as a file in an installable format or an executable format.

Moreover, a computer program executed by each of the display terminal 2, the management device 3, and the moving body 6 of the present embodiment may be configured to be stored in a computer connected to a network such as the Internet and provided by being downloaded via the network. Moreover, a program executed by each of the display terminal 2, the management device 3, and the moving body 6 of the present embodiment may be configured to be provided or distributed via a network such as the Internet.

Alternatively, a computer program executed by each of the display terminal 2, the management device 3, and the moving body 6 of the present embodiment may be configured to be provided by being incorporated in advance in a ROM or the like.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A delivery management device comprising
a hardware processor connected to a memory and configured to function as:
a delivery planning unit to create a delivery plan on the basis of delivery information related to delivery destinations and of accumulated battery data;
a charging planning unit to determine whether or not en-route charging is necessary, the en-route charging being performed to charge a battery mounted on a moving body midway through a delivery route defined in the delivery plan, the determination being made on the basis of power consumption of the moving body, the power consumption estimated from the delivery plan, and characteristics of the battery; and
a delivery management unit to determine whether or not to re-plan the delivery plan including the en-route charging, the determination being made on the basis of a deterioration state of the battery of the moving body, the determination being made in a case where the en-route charging is determined as being necessary and where a battery deterioration amount is set as a priority item from among a delivery amount and the battery deterioration amount for delivery by the moving body.

2. The delivery management device according to claim 1, wherein, in a case where SOH indicating the deterioration state of the battery is larger than a predetermined threshold value, the delivery management unit determines not to re-plan the delivery plan including the en-route charging and adopts the delivery plan including the en-route charging.

3. The delivery management device according to claim 1, wherein, in a case where SOH indicating the deterioration state of the battery is less than or equal to a predetermined threshold value, the delivery management unit determines to re-plan the delivery plan including the en-route charging.

4. The delivery management device according to claim 1, wherein the delivery management unit adopts the delivery plan including the en-route charging in a case where the delivery amount is set as the priority item and where the en-route charging is determined as being necessary.

5. The delivery management device according to claim 1, wherein the delivery management unit adopts the delivery plan in a case where the en-route charging is determined as not being necessary.

6. The delivery management device according to claim 1, wherein the delivery planning unit re-plans the delivery plan by changing at least one of the moving body, a delivery amount by the moving body, and the number of moving bodies.

7. A delivery management system comprising:
the delivery management device according to claim 1; and
a display terminal configured to display a display screen for selecting at least one of change items including the moving body, the delivery amount by the moving body, and the number of moving bodies, the display screen being displayed in a case where the delivery management device determines to re-plan the delivery plan including the en-route charging.

8. A display terminal comprising:
a hardware processor connected to a memory and configured to function as a display unit to display a display screen for selecting at least one of change items including a moving body, a delivery amount by the moving body, and the number of moving bodies, the display screen being displayed in a case where
a delivery plan includes en-route charging, the delivery play being created on the basis of delivery information related to delivery destinations and of accumulated battery data, the en-route charging being performed to charge a battery mounted on the moving body midway through a delivery route defined in the delivery plan,
a battery deterioration amount is set as a priority item from among a delivery amount and the battery deterioration amount for delivery by the moving body, and
a determination is made, on the basis of a deterioration state of the battery of the moving body, to re-plan the delivery plan including the en-route charging; and
an input device configured to receive selection of the at least one of change items by a user.

9. The display terminal according to claim 8, wherein the display unit displays a display screen including at least one of
a delivery plan re-planned in accordance with the selection of the at least one of change items received by the input device, and
a charging plan created on the basis of the delivery plan.

10. The display terminal according to claim 8, wherein
the display unit displays the display screen for selecting the at least one of change items for each moving body, and
the input device receives the selection of the change item for each moving body.

11. A delivery management method comprising:
creating a delivery plan on the basis of delivery information related to delivery destinations and of accumulated battery data;
determining whether or not en-route charging is necessary, the en-route charging being performed to charge a battery mounted on a moving body midway through a delivery route defined in the delivery plan, the determining being performed on the basis of power consumption of the moving body, the power consumption estimated from the delivery plan, and characteristics of the battery; and
determining whether or not to re-plan the delivery plan including the en-route charging, the determining being performed on the basis of a deterioration state of the battery of the moving body, the determining being performed in a case where the en-route charging is determined as being necessary and where a battery deterioration amount is set as a priority item from among a delivery amount and the battery deterioration amount for delivery by the moving body.
